(19) United States
(12) Patent Application Publication
(10) Pub. No.: US 2026/0178500 A1
(43) Pub. Date: Jun. 25, 2026

(54) Stacked Die Configuration with Metadata Storage

(71) Applicant: Advanced Micro Devices, Inc., Santa Clara, CA (US)

(72) Inventors: Gabriel Hsiuwei Loh, Bellevue, WA (US); Zachary Blair, San Jose, CA (US); Patrick James Shyvers, Fort Collins, CO (US); John Kalamatianos, Arlington, MA (US)

(73) Assignee: Advanced Micro Devices, Inc., Santa Clara, CA (US)

(21) Appl. No.: 18/999,534

(22) Filed: Dec. 23, 2024

(51) Int. Cl. G06F 12/0862; G06F 9/46; G06F 12/0811

(52) U.S. Cl. CPC G06F 12/0862; G06F 9/461; G06F 12/0811

(57) ABSTRACT

Metadata storage for a stacked die configuration is described. In accordance with the described techniques, a system includes a first die that has one or more processor cores and shared cache. The system also includes a second die with metadata storage. In response to a context switch or power state transition for the one or more processor cores, a metadata controller causes metadata associated with the one or more processor cores to be saved in the metadata storage on the second die. The metadata controller also loads metadata associated with the new context (e.g., a different process or thread) or the new power state from the metadata storage.

### BACKGROUND

Processors use prefetching to minimize the delay in accessing memory. For example, prefetchers retrieve data and instructions predicted to be used by a workload (e.g., an application or process) and store the instruction in a memory source, such as a cache, accessible to the processor at increased speed compared to the original memory source. To improve prefetching accuracy, prefetchers learn a workload’s access patterns dynamically. However, when a processor switches to another workload, the history and patterns learned for a workload are typically lost, resulting in the prefetcher learning this prediction information from scratch the next time the workload is executed.

### BRIEF DESCRIPTION OF THE DRAWINGS

FIG. 1 is a block diagram of a non-limiting example system having one or more dies operable to implement a stacked die configuration with metadata storage.

FIG. 2 is a non-limiting example top view and side view of a stacked die configuration.

FIG. 3 depicts a non-limiting example system having a stacked die and a base die operable to implement metadata storage for a stacked die configuration.

FIG. 4 depicts a non-limiting example system having a base die and stacked die operable to implement a stacked die configuration with metadata storage.

FIG. 5 depicts a procedure in an example implementation of metadata storage for a stacked die configuration.

FIG. 6 is a block diagram of a processing system configured to execute one or more applications, in accordance with one or more implementations.

### DETAILED DESCRIPTION

### Overview

As described above, prefetching improves processor performance. For example, prefetchers retrieve data or instructions predicted to be used by a workload (e.g., an application or process) and store the instruction in a memory source, such as a cache, accessible at increased speed compared to the original memory source. To improve prefetching accuracy, prefetchers learn a workload’s access history and patterns dynamically. When a processor switches context (e.g., to execute another application or process), the learned history and patterns are typically lost, resulting in the prefetcher learning this prediction information from scratch the next time the workload is executed. Similarly, when a processor undergoes a power state transition, microarchitectural state data (e.g., registers, program counter value, memory management unit state data, cache content, and interrupt masks) is saved or restored to preserve the processor’s state.

In addition, many log-to-memory features (e.g., for debugging purposes) are limited by the bandwidth available to main memory, which in turn can limit how much (or how frequently) information is logged. Reduced logging frequency creates coverage gaps and makes system debugging more difficult. Alternatively, logging frequency can be increased, but this increases memory contention and alters system performance in ways that change the observations.

One conventional approach to address these issues is a high-bandwidth sideband memory, such as static random access memory (SRAM). Sideband memory can store processor metadata (e.g., data and instruction access history and patterns for particular processes or applications), state data, or behavior logs. Storing this data in SRAM-based storage does not scale well and is expensive in terms of chip area, especially in scenarios including multiple processes and applications.

Another conventional technique is to reserve a portion of the main system memory to store the processor metadata, state data, and logs. However, this use of main memory reduces the usable memory capacity for a system, which is increasingly being utilized by the growing number of applications and machine-learning features. In addition, accessing this data adds congestion to the limited bandwidth from the processor to main memory, exacerbated as an operating system schedules other applications and processors to the processor.

In contrast, this document describes techniques and systems for a stack die configuration with metadata storage. The stacked die configuration includes a base die with one or more processors and a stacked die with dynamic random access memory (DRAM) or another memory configuration to store processor metadata, including prefetching metadata (e.g., prefetcher patterns), branch predictor history, branch target buffer entries, memory access patterns, processor state data, and data logs. The data logging includes, for example, software logging (e.g., instruction tracking, debugging), performance tracking (e.g., performance counter logging), and dumping microarchitectural state for hardware debugging. The processor metadata, for example, is stored in a reserved portion of the memory on the stacked die. In this way, processor performance is improved, especially for processing environments that include multiple processes or applications sharing multiple cores. In addition, the described techniques and systems enable higher bandwidth logging, increased logging, and lower system perturbation under measurement.

In some aspects, the techniques described herein relate to a system comprising a first die comprising one or more processor cores and a second die comprising metadata storage configured to store metadata generated by the one or more processor cores.

In some aspects, the techniques described herein relate to a system wherein the second die is stacked on, below, or beside the first die.

In some aspects, the techniques described herein relate to a system wherein the first die includes multiple processor cores and the second die includes multiple metadata storage slices, each metadata storage slice of the multiple metadata storage slices associated with a corresponding processor core of the multiple processor cores.

In some aspects, the techniques described herein relate to a system wherein the first die further comprises multiple shared cache slices and the second die further comprises multiple cache slices, each cache slice of the multiple cache slices associated with a corresponding shared cache slice.

In some aspects, the techniques described herein relate to a system wherein the system further comprises a metadata interface communicatively coupling each metadata storage slice to the corresponding processor core and a data interface communicatively coupling each cache slice to the corresponding shared cache slice, the metadata interface located closer to components of the corresponding processor core than the data interface.

In some aspects, the techniques described herein relate to a system wherein the metadata interface is inaccessible by an operating system, a hypervisor, or an application associated with the multiple processor cores.

In some aspects, the techniques described herein relate to a system wherein the multiple metadata storage slices and the multiple cache slices comprise dynamic random access memory (DRAM), embedded DRAM, static random access memory (SRAM), or nonvolatile memory.

In some aspects, the techniques described herein relate to a system wherein the metadata comprises at least one of branch prediction history, branch target buffer entries, instruction prefetcher training, instruction prefetcher pattern history, data prefetcher training, data prefetcher pattern history, or memory dependence predictor states.

In some aspects, the techniques described herein relate to a system wherein the metadata further comprises at least one of software logs for one or more applications executed by the one or more processor cores, performance logs for the one or more processor cores, or hardware debugging data for the one or more processor cores.

In some aspects, the techniques described herein relate to a system wherein the metadata includes multiple metadata sets, each metadata set associated with a particular process or a particular thread executed by the one or more processor cores.

In some aspects, the techniques described herein relate to a system wherein a metadata set associated with a first process or a first thread is saved to the metadata storage in response to a context switch to a second process or a second thread at the one or more processor cores.

In some aspects, the techniques described herein relate to a method comprising generating, by a first process or a first thread of a processor on a first die, metadata and in response to a context switch of the processor to a second process or a second thread, causing, by a metadata controller of the processor, the metadata to be saved in metadata storage of a second die.

In some aspects, the techniques described herein relate to a method wherein the method further comprises in response to the context switch to the second process or the second thread, determining, by the metadata controller, whether other metadata associated with the second thread or second process is stored in the metadata storage.

In some aspects, the techniques described herein relate to a method wherein the method further comprises in response to determining that the other metadata associated with the second thread or the second process is stored in the metadata storage, loading the other metadata into one or more corresponding components of the processor.

In some aspects, the techniques described herein relate to a processor comprising one or more processor cores on a first die and a metadata controller on the first die and communicatively coupled to the one or more processor cores, the metadata controller configured to store metadata generated by the one or more processor cores in metadata storage on a second die.

In some aspects, the techniques described herein relate to a processor wherein the metadata controller is further configured to use a status table to monitor one or more sets of metadata stored in the metadata storage associated with one or more processes or one or more threads executed by the one or more processor cores.

In some aspects, the techniques described herein relate to a processor wherein the metadata controller is further configured to identify, using the status table, a location of metadata associated with a process or a thread in the metadata storage in response to a context switch.

In some aspects, the techniques described herein relate to a processor wherein the first die includes multiple processor cores, each processor core including a corresponding metadata controller, and the metadata storage includes multiple metadata storage slices, each metadata storage slice associated with a corresponding processor core and storing the metadata associated with the corresponding processor core.

In some aspects, the techniques described herein relate to a processor wherein each metadata controller is further configured to use a shared status table to monitor one or more sets of metadata stored in the multiple metadata storage slices, each entry in the shared status table including an identifier of a processor core that generated a corresponding set of metadata, a slice identifier of a metadata storage slice storing the corresponding set of metadata, and an address space identifier or process context identifier associated with a process or a thread that generated the corresponding set of metadata.

In some aspects, the techniques described herein relate to a processor wherein the multiple metadata storage slices use a unified metadata cache address space with each metadata storage slice having a unique starting memory address.

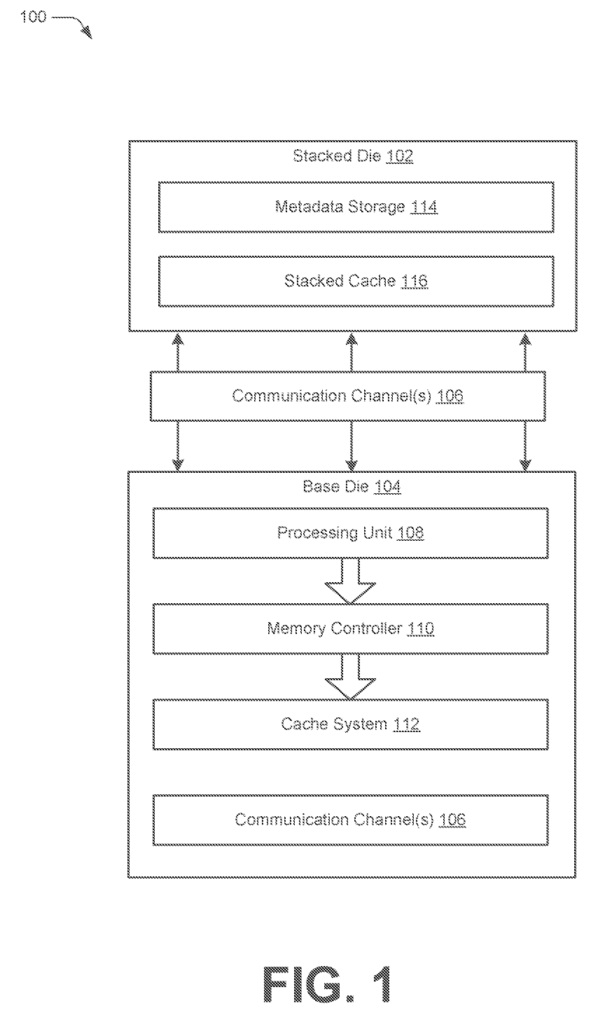

FIG. 1 is a block diagram of a non-limiting example system 100 having one or more dies operable to implement a stacked die configuration with metadata storage. In this example, the system 100 includes a stacked die 102 and a base die 104, as well as one or more communication channels 106. The base die 104 include one or more functional units, including a processing unit 108, a memory controller 110, and cache system 112 that are communicatively coupled, one to another. In other implementations, the processing unit 108, memory controller 110, and cache system 112 are included on the stacked die 102.

The stacked die 102 and/or the base die 104 are configurable to be implemented by a device in a variety of ways. Examples of which include, by way of example and not limitation, computing devices, servers, mobile devices (e.g., wearables, mobile phones, tablets, laptops), processors (e.g., graphics processing units, central processing units, and accelerators), field-programmable gate arrays, accelerators, digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device is configured as any one or more of those devices listed just above and/or a variety of other devices without departing from the spirit or scope of the described techniques.

In the illustrated example, the processing unit 108 executes software (e.g., an operating system, applications, etc.) to issue a memory request to the memory controller 110. The memory request is configurable to cause data storage (e.g., programming) to physical memory as a write request or read data from the cache system 112 as a read request. The memory controller 110 is configured to manage the use of memory cells in the cache system 112. Memory cells are configured in the hardware of the cache system 112 as electronic circuits that are used to store data. In one or more implementations, the data includes sequences of bits that represent information, including, but not limited to, instructions for executing tasks or operations between different functional units of the stacked die 102 and/or the base die 104, addresses for the memory cells, audio data representing audio samples, image data representing image frames, video data representing video frames, control signaling that manages settings, configurations, and operation of the functional units, and/or raw sensor readings representing physical measurements transferred between one or more sensors and the processing unit 108, among other examples of data. It is to be appreciated also, that in at least one variation, the system 100 does not include one or more of the depicted components and/or includes different components without departing from the spirit or scope of the described techniques.

In one or more implementations, during a manufacturing process of a processor and/or memory, a semiconductor material is split into individual semiconductor components, referred to as dies (e.g., the stacked die 102 and/or the base die 104). In variations, the stacked die 102 and/or the base die 104 are configured to implement aspects of a memory and/or a processor. By way of example, the stacked die 102 and/or the base die 104 include circuitry configured to store and access data and/or execute instructions. The circuitry includes one or more transistors and/or switches arranged to implement the functionality of a processor and/or memory. The circuitry is arranged and applied using logic that enables the stacked die 102 and/or the base die 104 to carry out the functionalities described above and below.

The stacked die 102 and/or the base die 104 include one or more execution units, control units, registers, cache memories, and other functional units that enable execution of instructions. Execution units are functional components within a processor that perform types of operations, including arithmetic operations, logic operations, and/or operations related to data movement. Example execution units include, but are not limited to, an arithmetic logic unit (ALU) for performing basic arithmetic, a floating-point unit (FPU) for performing floating-point arithmetic operations, a load-store unit for loading data from memory into registers and storing data from registers back to memory, and a memory management unit to translate virtual addresses to physical addresses for memory access and management, to name just a few.

A control unit (e.g., the processing unit 108, the memory controller 110, and/or a unit communicatively coupled with the memory controller 110 or the processing unit 108) manages the execution of instructions, directs the flow of data, and coordinates operations within the stacked die 102 and/or the base die 104. For example, a control unit manages the execution of instructions retrieved from memory, including decoding the instructions and controlling the data flow in response to the instructions between different components of the stacked die 102 and/or the base die 104.

In one or more implementations, the cache system 112 includes one or more registers and/or one or more cache memories accessible by one or more processor cores of the base die 104 and/or stacked die 102. The memory controller 110 utilizes registers to store and access data being processed or manipulated. Additionally, or alternatively, the stacked die 102 and/or the base die 104 utilize one or more cache memories, including the cache system 112, a metadata storage 114, and a stacked cache 116 to store and access frequently utilized data.

The cache system 112 corresponds to semiconductor memory, where data is stored within memory cells on one or more integrated circuits. The cache system 112 includes a hierarchy of multiple cache levels, including a level one cache, a level two cache, and a last-level cache, also called a level three (L3) cache or a shared cache. For example, the base die 104 is a multi-core processor, and each respective processing unit 108 includes the level one cache and level two cache, which are exclusively used by the respective processing unit 108. Furthermore, the base die 104 includes the last level cache, which is shared among the multiple processing units 108.

Higher cache levels (e.g., level one caches) are accessible (e.g., for loading and/or storing data) relatively faster than the lower cache levels (e.g., last-level caches). Lower cache levels in the hierarchy of cache levels generally have greater memory capacity than higher levels. In other implementations, the cache system 112 includes differing numbers of cache levels and different hierarchical structures without departing from the spirit or scope of the described techniques. For example, the processing units 108 share a different level cache or multiple level caches in another implementation.

The stacked cache 116 acts as an extension to the cache system 112 for the base die 104 or as additional cache memory for the processing unit 108. Similar to the cache system 112, the stacked cache 116 corresponds to semiconductor memory, where data is stored within memory cells on one or more integrated circuits.

The cache system 112 and stacked cache 116 are accessible (e.g., for loading and/or storing data in response to access requests by the processing unit 108) relatively faster than the main memory located on another die or chip, which is located outside the hierarchy of the cache system 112. The various memory sources of base die 104 are ordered from fastest access speed to slowest access speed in the following order: (1) the level one cache of the cache system 112, (2) the level two cache of the cache system 112, (3) the level three cache of the cache system 112, (4) the stacked cache 116, (5) volatile memory of main memory, and (6) non-volatile memory of main memory.

The stacked die 102 and/or the base die 104 are manufactured from a substrate layer (e.g., made from silicon) and include electronic circuits that perform various operations on and/or using data in the cache system 112 or the stacked cache 116. Examples of the base die 104 include, but are not limited to, a central processing unit (CPU), a graphics processing unit (GPU), a field programmable gate array (FPGA), an accelerator, an accelerated processing unit (APU), and a digital signal processor (DSP), to name a few. Examples of the stacked die include, but are not limited to, dynamic random access memory (DRAM), embedded DRAM (eDRAM), static random access memory (SRAM), latch arrays, and non-volatile memory (e.g., phase change memory, ferroelectric memory, spin-torque transfer magnetoresistive memory). The processing unit 108, also referred to as a core, reads and executes instructions (e.g., of a program), examples of which include adding, moving data, and branching. Although one processing unit 108 is depicted in the illustrated example, in variations, the stacked die 102 and/or the base die 104 include more than one processing unit 108 (e.g., a multi-core processor).

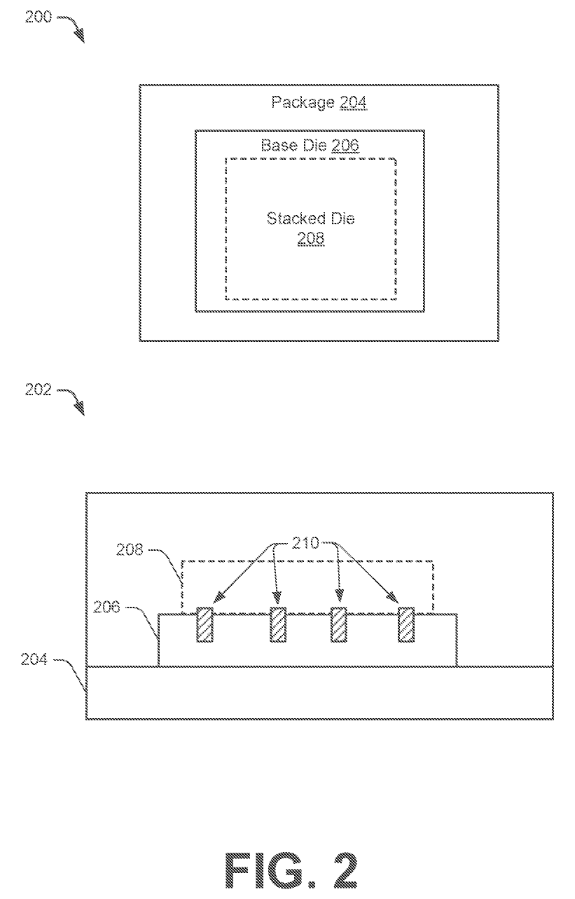

In one or more implementations, the stacked die 102 and the base die 104 are manufactured in a 3D architecture, such that one or more processor components and/or memory components (e.g., the stacked die 102) are bonded to a base die 104. The bonded components and the base die 104 make up a chip. In variations, the stacked die 102 and the base die 104 are manufactured independently and subsequently assembled via bonding techniques as layers in a stack of processor and/or memory components, which is described in further detail with respect to FIG. 2. Vertical interconnects, referred to as through-silicon vias (TSVs), are introduced in the stacked die 102 and/or the base die 104 to provide communication between the different layers or dies in the stack. It is to be appreciated that the base die 104 has any numerical quantity of stacked dies 102. In some other examples, the base die 104 is manufactured in a 2D architecture, such that the base die 104 does not have a stacked die 102. That is, the base die 104 is optionally coupled with the stacked die 102. In other implementations, the stacked die 102 and the base die 104 manufactured in a 2D architecture are stacked on a common substrate such as a silicon interposer, organic substrate, or other suitable packaging technologies that may or may not include TSVs.

The dies representing the different layers of a stack for a 3D architecture and/or a die in a 2D architecture are configured to implement the functionality of a processor and/or memory by utilizing communication channels 106. Communication channels 106 are components of system 100 that facilitate the movement of data between components of a die for 2D architecture and components of multiple dies in a stack for 3D architecture. For example, the communication channels 106 provide for routing data between the processing unit 108, the memory controller 110, the cache system 112, the metadata storage 114, and/or the stacked cache 116 in addition, or as an alternative, to other components of the stacked die 102 and the base die 104. Example communication channels 106 include, but are not limited to, TSVs when moving data between layers and/or memory channels, buses (e.g., a data bus), interconnects, traces, or planes within a die to move data to different destinations or components of the die. The stacked die 102 and/or the base die 104 include communication channels 106 disposed within the stacked die 102 and the base die 104, respectively. In variations, the base die 104 includes additional communication channels 106 disposed within the base die 104 and directed towards the stacked die 102.

In variations, the communication channels 106 are part of an on-chip network. The on-chip network is also referred to as a network-on-chip, an interconnect fabric, or a data fabric. An on-chip network includes one or more switches to enable routing of data packets between components, communication channels 106, buffers for temporarily storing data packets, and routing logic or steering logic to determine a path for data packets to take from an initial destination to a target destination, among other features.

The metadata storage 114 stores metadata associated with a workload, application, process, thread, or processing unit 108. The metadata represents information regarding the behavior and performance of a workload, application, process, thread, or processing unit from a hardware and/or software perspective. The metadata includes but is not limited to, branch prediction history (e.g., counter values, tags, confidence bits), branch target buffer (BTB) entries, instruction prefetcher training and pattern history, data prefetcher training and pattern history, processor state data, data logs, and memory dependence predictor state. In response to a context switch, the processing unit 108 saves microarchitecture metadata to the metadata storage 114. In response to loading a process or thread, a metadata controller of the processing unit 108 checks the metadata storage 114 for saved metadata corresponding to the process or thread. If so, the processing unit 108 restores the associated metadata back to the respective microarchitectural structures without involving a relearning or reestablishment of the metadata. Similarly, the metadata storage 114 stores power state data (e.g., registers, program counter value, memory management unit state data, cache content, and interrupt masks), which is saved or restored as the processing unit 108 undergoes a power state transition.

FIG. 2 depicts a non-limiting example top view 200 and side view 202 of a stacked die configuration. The non-limiting example top view 200 and side view 202 include, or are implemented by, aspects of the system 100. For example, the non-limiting example top view 200 and side view 202 include a package 204 with a base die 206, a stacked die 208, and one or more communication channels 210, where the base die 206 is an example of a base die 104, the stacked die 208 is an example of a stacked die 102, and the communication channels 210 are examples of communication channels 106, as described with reference to FIG. 1.

The stacked die 208 is depicted above a portion of the base die 206, however, in one or more variations the stacked die 208 is below the base die 206. The base die 206 is depicted as adjacent to, or touching, the stacked die 208. In one or more implementations, additional layers are arranged between the base die 206 and the stacked die 208 (e.g., dielectric layers for electrically isolating individual layers). In other variations, the base die 206 and the stacked die 208 are stacked adjacent to each other on a common substrate such as but not limited to a silicon interposer, an organic substrate, a glass substrate, or a ceramic substrate.

In one or more implementations, one or more dies that make up an integrated circuit or chip are housed by a package 204. The package 204 provides mechanical support, electrical insulation, heat dissipation, and connection points for external circuitry, among other benefits, for the dies. In variations, package 204 is manufactured from ceramic, plastic, and/or metal alloys. Although the package 204 is illustrated as surrounding the base die 206 and the stacked die 208, the package 204 is any shape or size.

As described with reference to FIG. 1, one or more dies that make up a chip are optionally stacked during a manufacturing process. For example, a base die 206 is configured to be coupled with one or more stacked dies 208. In variations, although the base die 206 is configured to be coupled with the stacked dies 208, the base die 206 is not coupled with the stacked dies 208. That is, the base die 206 makes up the chip (e.g., without additional dies). An example 3D die, or stacked die, configuration includes, but is not limited to, one or more dies stacked vertically on top of a base die 206. Coupling the stacked dies 208 to the base die 206 and/or to another stacked die 208 includes bonding the stacked dies 208 to the base die 206 and/or to the other stacked die 208.

In one or more variations, a base die 206 and/or a stacked die 208 detects the presence or absence of another die. For example, logic at the base die 206 detects the presence of one or more stacked die 208, while logic at the stacked die 208 detects the presence of the base die 206 and/or one or more additional stacked dies 208. In one or more implementations, the base die 206 and/or the stacked dies 208 include solder joints that contact a pad on an adjacent die to create an electrical connection. A pad is a dedicated area on the base die 206 and/or the stacked die 208 used for making electrical connections between the die and external components, used for testing during a manufacturing process, used for distributing power supply voltages and ground connections to inner circuitry of the die, and/or used for connecting input and output signals between the die and external components or systems. Example pads include, but are not limited to, metalized areas on the surface of a die or TSVs that pass through the die. In other variations, the base die 206 and/or the stacked die 208 do not include solder joints and the pads are connected with a direct-contact manufacturing process such as hybrid bonding. The base die 206 and/or the stacked die 208 utilizes information regarding whether the electrical connection is established or not to detect the presence of the stacked die 208 (e.g., to detect whether the dies are in a 3D die configuration). In variations, the information includes a signal that indicates the connection is established.

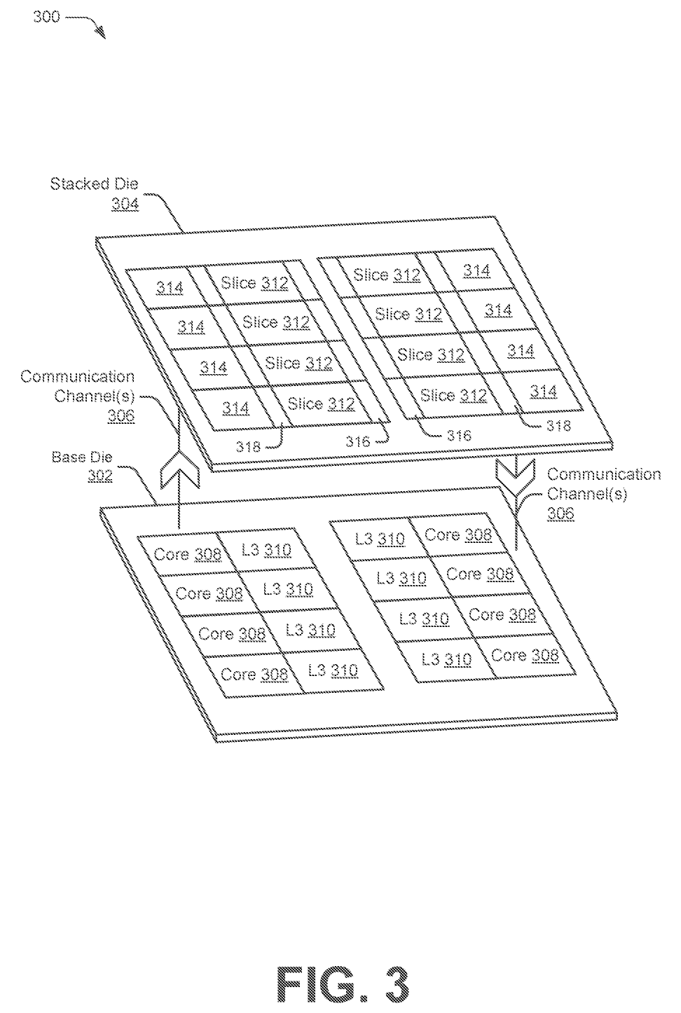

The base die 206 includes one or more communication channels 210 for routing data from an initial, or source, location on the base die 206 to a target destination on the base die 208, which is described in further detail with respect to FIG. 3. Similarly, the stacked die 208 includes one or more communication channels 210 for routing data from an initial, or source, location on the stacked die 208 to a target destination on the stacked die 208, which is described in further detail with respect to FIG. 3.

FIG. 3 depicts a non-limiting example system 300 having a stacked die and a base die operable to implement metadata storage for a stacked die configuration. The non-limiting example system 300 includes, or is implemented by, aspects of the system 100 and the non-limiting example top view 200 and side view 202. For example, the non-limiting example system 300 includes a base die 302, a stacked die 304, and one or more communication channels 306, which are examples of the corresponding features as described with reference to FIGS. 1 and 2. The base die 302 includes multiple processor cores 308 (e.g., processing units 108 of FIG. 1) and level three (L3) (or shared) cache slices 310 (e.g., shared cache of the cache system 112). The stacked die 304 includes multiple cache slices 312 (e.g., stacked cache 116 of FIG. 1), metadata storage slices 314 (e.g., metadata storage 114 of FIG. 1), cache interfaces 316, and metadata interfaces 318.

Although the stacked die 304 is illustrated as being suspended over the base die 302, in variations, the stacked die 304 is at any orientation relative to the base die 302 (e.g., next to, above, below, etc.). In some examples, the stacked die 304 is coupled with the base die 302, as described with reference to FIG. 2.

The shared cache of the cache system 112 is implemented as multiple L3 cache slices 310. The multiple L3 cache slices 310 (e.g., four or eight slices) act as subsections of the cache system 112. The L3 cache slices 310 are similar to smaller caches that work together to improve the overall efficiency and performance of the last level or shared cache within the cache system 112. By distributing data access across the L3 cache slices 310, the overall bandwidth of the last level cache is used more efficiently.

Similarly, the stacked cache 116 is implemented as multiple cache slices 312. The multiple cache slices 312 (e.g., four or eight slices) act as subsections of the stacked cache 116. The cache slices 312 are similar to smaller caches that work together to improve the overall efficiency and performance of the last level or shared cache within the stacked cache 116. By distributing data access across the cache slices 312, the overall bandwidth of the stacked cache 116 is used more efficiently. Each cache slice 312 includes a cache interface 316 to read and write tags and data to and from the corresponding cache slice 312 and the L3 cache slice 310. The cache interface 316 is ideally located to minimize latency between the L3 cache slices 310 and the corresponding cache slices 312.

As shown, system 300 includes multiple processor cores 308. System 300 is illustrated as including eight processor cores 308 and eight L3 cache slices 310. Other implementations include fewer or additional processor cores 308 and/or L3 cache slices 310.

Each processor core 308 generates microarchitectural metadata associated with executing different workloads, including processes and threads, and architectural state data associated with the power state of the processor core 308. Examples of this metadata include, but are not limited to, branch prediction history (e.g., counter values, tags, confidence bits), branch target buffer entries, instruction prefetcher training and pattern history, data prefetcher training and pattern history, and memory dependence predictor state. Examples of the architectural state data include registers (e.g., general-purpose, special-purpose, and control registers), program counter (PC) value, memory management unit state data (e.g., page tables and translation look-aside buffers), cache contents, and interrupt masks. The metadata and state data are used by the processor core 308 to improve the performance and efficiency of the system 300. The described techniques allow the processor core 308 to save this metadata and state data in a corresponding metadata storage slice 314.

The multiple metadata storage slices 314 (e.g., four or eight slices) are subsections of the metadata storage 114. The metadata storage slices 314 are similar to smaller caches that work together to improve the overall efficiency and performance of the metadata storage 114. By distributing data access across the multiple metadata storage slices 314, the overall bandwidth of the metadata storage 114 is used more efficiently.

The system 300 includes a metadata interface 318 that communicatively couples a processor core 308 to a corresponding metadata storage slice 314. The metadata interface 318 is advantageously placed near core components with the described metadata and state data to reduce latency and conserve power. Upon a context switch at a particular processor core 308 (e.g., when the process context identifier (PCID) or address space identifier (ASID) changes or updates) or a power state transition, the processor core 308 saves microarchitecture metadata or power state data to the corresponding metadata storage slice 314 through the metadata interface 318. As indicated above, the context switch corresponds to a change in the process or thread executed by the processor core 308 as indicated by a change in the PCID or the ASID. When a new PCID or ASID is loaded, a metadata controller in the processor core 308 checks the corresponding metadata storage slice 314 to locate any saved metadata corresponding to that PCID or ASID. If so, the metadata controller restores this metadata to the respective microarchitectural structures of the processor core 308. Similarly, state data is saved or restored in response to a power state transition of the processor core 308.

In other implementations or use cases, the processor cores 308 store log data, including instructions executed or retired, register data values, memory data values, performance counters, and debug registers. In one implementation, the metadata interface 318 or a parallel interface is set up as a privileged interface (e.g., via the kernel, driver, or accessible just by a specific BIOS) for tracing.

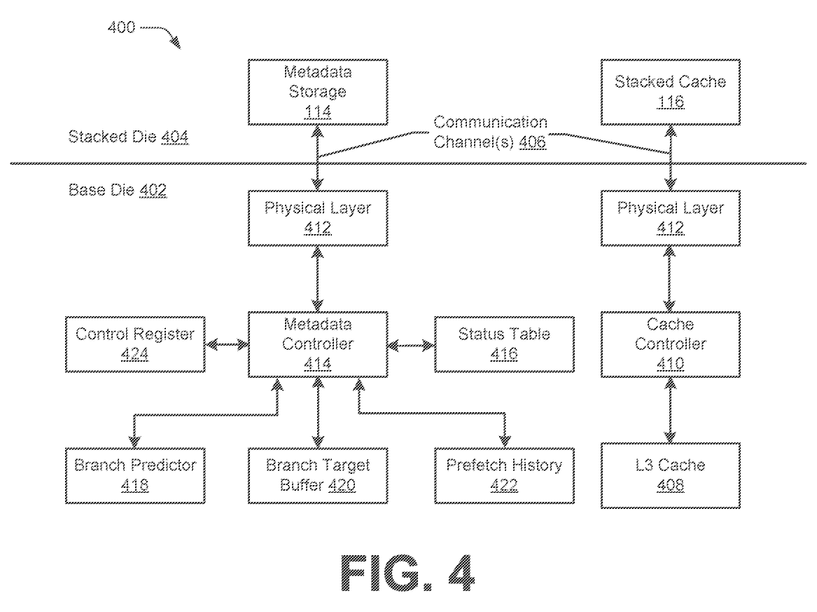

FIG. 4 depicts a non-limiting example system 400 having a base die and stacked die operable to implement a stacked die configuration with metadata storage. The non-limiting example system 400 includes, or is implemented by, aspects of the system 100 and the non-limiting example top view 200 and side view 202. For example, the non-limiting example system 400 includes a base die 402 and a stacked die 404 and multiple communication channels 406, which are examples of the corresponding features as described with reference to FIGS. 1-3.

The shared cache of the cache system 112 is implemented as a L3 cache 408. In one implementation, the L3 cache 408 includes multiple L3 cache slices 310. The L3 cache 408 is communicatively coupled to a cache controller 410, which is communicatively coupled to the stacked cache 116 via a physical layer 412. In one implementation, the stacked cache 116 includes multiple cache slices 312. The cache controller 410 manages operations of the cache system 112, including determining whether to store data in the L3 cache 408 or the stacked cache 116 and data transfer between the system 400 and the cache system 112 or internal to the cache system 112 between the L3 cache 408 and the stacked cache 116. The physical layer 412 manages the transmission and reception of data between the L3 cache 408 and the stacked cache 116, including converting digital data into electrical signals for transmission over the communication channels 406.

The metadata storage 114 is communicatively coupled to a metadata controller 414 via the physical layer 412. In one implementation, the metadata storage 114 includes multiple metadata storage slices 314. The metadata controller 414 manages the storage and retrieval of metadata in the metadata storage 114. The system 400 generally includes a metadata controller 414 for each processor core 308. To identify the type and sets of metadata currently saved in the metadata storage 114, the metadata controller 414 uses a status table 416. The status table 416 tracks the saved metadata by PCID and/or ASID. In one implementation, the status table includes one or more entries, with each entry including a valid bit, a PCID or ASID, and an index or address into the metadata storage 114 where the metadata is stored. In the illustrated implementation of system 400, the status table 416 is located on the base die 402 (e.g., in an SRAM array on a processor core 308). In another implementation, the status table 416 is located on the stacked die 404 as part of the metadata storage 114.

As described above, the processor core 308 generates microarchitectural metadata for executing different processes and threads. Examples of this metadata include, but are not limited to, branch prediction history (e.g., counter values, tags, confidence bits) from a branch predictor 418, branch target buffer entries from a branch target buffer 420, prefetch history 422 (e.g., instruction prefetcher training, instruction prefetching pattern history, data prefetcher training, and data prefetching pattern history), and memory dependence predictor state. The processor core 308 also generates state data associated with one or more power states.

Upon a context switch at the processor core 308 (e.g., beginning execution of a different process or thread), the metadata controller 414 saves microarchitecture metadata or state data to the metadata storage 114 concurrent with an operating system saving the processor state (e.g., instruction set architecture (ISA) registers) to main memory. The interface between the base die 402 and the stacked die 404 generally has a higher bandwidth than the interface between the base die 402 and another die on which the main memory is located. As a result, the metadata controller 414 is able to save the microarchitecture metadata to the metadata storage 114 before the operating system starts or resumes a new process or thread on the processor core 308.

When the operating system launches a process or thread on the processor core 308, the metadata controller 414 checks the status table 416 to determine if metadata corresponding to the new process or thread exists in the metadata storage 114. For example, upon context switching, a value of a control register 424 (e.g., control register 3 (CR3)) is updated with the value associated with the PCID or ASID. The control register value assists the metadata controller 414 in checking the status table 416 for the presence of metadata associated with the new process or thread. If corresponding metadata is available, the metadata controller 414 retrieves this data from the metadata storage 114. If the corresponding metadata is not loaded into the corresponding core components before the execution of the new process or thread, the metadata controller 414 overlaps the metadata restoration as the process or thread is executing. In another implementation, the operating system code that restores the process or thread state (e.g., ISA registers) provides the metadata controller 414 with the PCID or ASID to restore the corresponding metadata concurrently with the context restoration from the main memory.

To further improve the effectiveness of the described techniques, the operating system or hypervisor of the system 400 schedules processes or threads to execute on the same processor core 308 as often as possible. Conventional techniques often use core affinity to pin processes or threads to cores. Such core affinity reduces the number of different metadata sets stored in each metadata storage slice 314 and the number of entries in the status table 416.

In virtualized servers, processes or threads running in containers or virtual machines generally do not pin processes or threads to particular cores 308, resulting in processes and threads being rescheduled on any available processor core 308 after a context switch. Similar scenarios also occur for applications running on client platforms or with NUMA-aware operating system schedulers that migrate threads or processes to improve the scalability of parallel applications on large-scale nodes. To reuse metadata across multiple cores 308 in such scenarios, the described techniques and systems utilize shared status tables and a unified metadata cache address space.

A shared status table is located (1) next to shared L3 caches 408 so that metadata is shareable among all cores within a CCD or (2) in a system directory (e.g., the Probe Filter) so that metadata is shareable among each processor core 308 within the system 400 (e.g., a SoC). Each entry of the shared status table tracks the core identifier associated with the metadata storage slice 314 that is storing the metadata associated with that entry. When a process or thread is context switched out, the corresponding table entry is copied from a core-local status table 416 to the shared status table. When the same process or thread is context switched in, the restoration flow checks the shared status table for a hit on the PCID or ASID of the incoming process or thread. If there is a hit at the shared status table, then the core identifier of the shared status table entry identifies the metadata storage slice 314 holding the microarchitectural state of the incoming process or thread and evicts it from the metadata storage slice 314 where the metadata is stored to the processor core 308 where the process or thread is scheduled. In addition, the core-local status table entry at the provider processor core 308 is invalidated. The shared status table entry is also copied to the core-local status table 416 of the destination processor core 308. When the same process or thread is context switched out, the new microarchitectural state is saved to the local metadata storage slice 314. The metadata cache address space is unified across each processor core 308 so that the starting location of metadata is unique among each metadata storage slice 314.

In response to the metadata storage 114 or a metadata storage slice 314 becoming full, the processor core 308 raises or issues an interrupt. In one implementation, the interrupt handler copies the metadata region to a predetermined region of main memory or to input/output devices where the metadata is retrievable. In another implementation, the metadata controller 414 stalls the processor core 308, copies the metadata or logged troubleshooting data to a predetermined region of main memory, resets the metadata region, and then resumes core execution (and logging). In another implementation, the metadata controller 414 performs the copy and reset of metadata regions without stalling the processor core 308.

Having discussed example systems and non-limiting examples of utilizing communication channels for a stacked die configuration, consider the following example procedures.

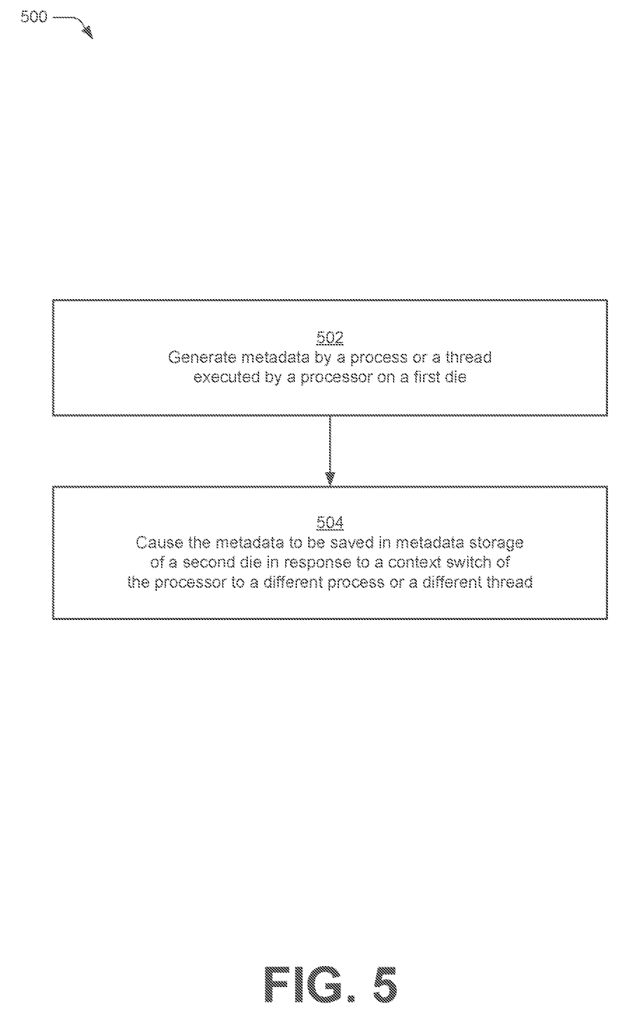

FIG. 5 depicts a procedure 500 in an example implementation of metadata storage for a stacked die configuration.

A processor on a first die generates metadata associated with a first process or a first thread executed by the processor (block 502). The metadata includes branch prediction history, branch target buffer entries, instruction prefetcher training, instruction prefetcher pattern history, data prefetcher training, data prefetcher pattern history, or memory dependence predictor states. In another implementation, the metadata includes state data associated with different power states of the processor. In yet another implementation, the metadata includes software logs for applications executed by the processor, performance logs for the processor, or hardware debugging data for the processor.

The first die also includes a metadata controller communicatively coupled to the processor. The metadata controller stores the metadata generated by processor in metadata storage on a second die, which is stacked on the first die in some configurations. The metadata storage includes multiple metadata storage slices and multiple cache slices communicatively coupled to multiple shared cache slices on the first die in at least one implementation. Each metadata storage slice is associated with a corresponding processor or processor core on the first die. A metadata interface communicatively couples each metadata storage slice to the corresponding processor, with the metadata interface being located closer to processor components than a data interface between the cache slices and the shared cache slices. The metadata interface is generally inaccessible by an operating system, hypervisor, or application associated with or executed by the processor. The metadata storage slices and cache slices comprise one or more memory technologies, including but not limited to dynamic random access memory (DRAM), embedded DRAM, static random access memory (SRAM), or nonvolatile memory.

In response to a context switch of the processor to a second process or a second thread or a power state transition, a metadata controller of the processor causes the metadata to be saved in metadata storage of the second die (block 504). In response to the context switch or the power state transition, the metadata controller determines whether other metadata associated with the second thread, second process, or other power state is stored in the metadata storage. If such metadata is present in the metadata storage, the metadata controller loads the other metadata into one or more corresponding processor components.

The metadata controller uses a status table to monitor the metadata sets stored in the metadata storage. The status table is saved in the metadata storage on the second die or in SRAM on the first die. In one implementation, each metadata controller (e.g., associated with each processor core of a SoC) uses a shared status table to monitor the metadata sets. Each entry in the shared status table includes an identifier of a processor core that generated a corresponding set of metadata, a slice identifier of a metadata storage slice storing the corresponding set of metadata, and an address space identifier or process context identifier associated with a process or a thread that generated the corresponding set of metadata. In addition, the multiple metadata storage slices can use a unified metadata cache address space with each metadata storage slice having a unique starting memory address.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the stacked die 102, the base die 104, the communication channels 106, the metadata storage 114, and the stacked cache 116) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

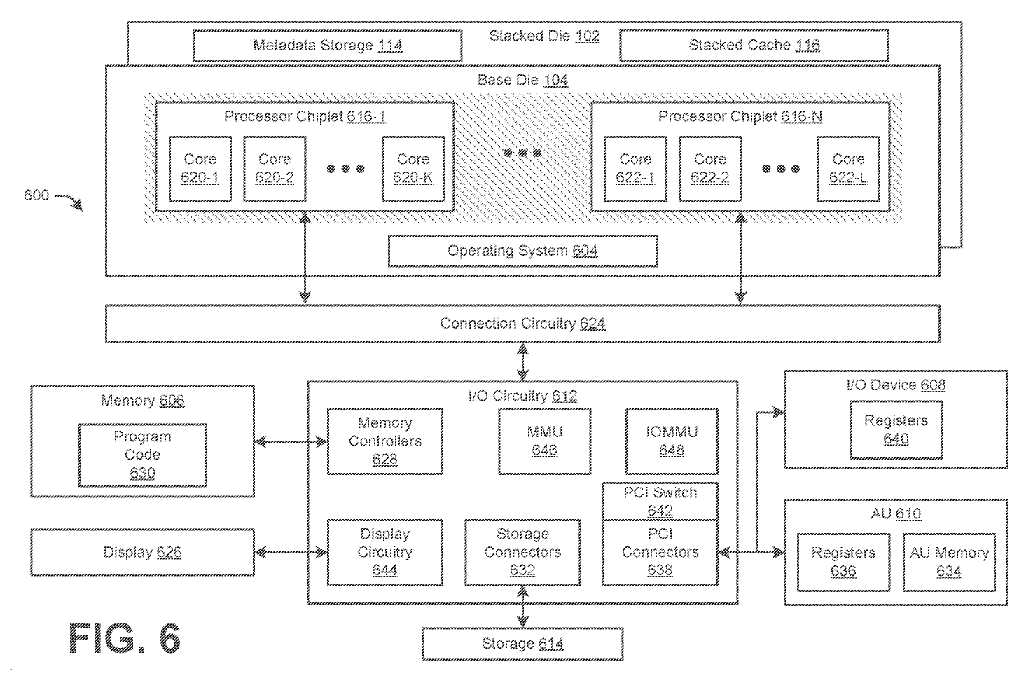

FIG. 6 is a block diagram of a processing system 600 configured to execute one or more applications, in accordance with one or more implementations.

FIG. 6 includes a processing system 600 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 600 includes a central processing unit (CPU), which includes a base die 104 and a stacked die 102, as described with reference to FIGS. 1 through 5. In one or more implementations, the CPU is configured to run an operating system (OS) 604 that manages the execution of applications. For example, the OS 604 is configured to schedule the execution of tasks (e.g., instructions) for applications, allocate portions of resources (e.g., system memory 606, CPU, input/output (I/O) device 608, accelerator unit (AU) 710, storage 614) for the execution of tasks for the applications, provide an interface to I/O devices (e.g., I/O device 608) for the applications, or any combination thereof.

In this example, the stacked die 102, the base die 104, and/or the communication channels 106 are in a CPU. The communication channels 106 can be implemented by data fabric or a portion of data fabric. The stacked die 102 includes the metadata storage 114 and the stacked cache 116. In variations, however, the stacked die 102 includes additional components. The base die 104 includes one or more processor chiplets 616, which are communicatively coupled together by communication channels 106 in one or more implementations.

Each of the processor chiplets 616, for example, includes one or more processor cores 620, 622 configured to concurrently execute one or more series of instructions, also referred to herein as “threads,” for an application. Further, the communication channels 106 communicatively couple each processor chiplet 616-N of the CPU, including the base die 104 and the stacked die 102, such that each processor core (e.g., processor cores 620) of a first processor chiplet (e.g., 616-1) is communicatively coupled to each processor core (e.g., processor cores 622) of one or more other processor chiplets 616. Though the example embodiment presented in FIG. 6 shows a first processor chiplet (616-1) having three processor cores (620-1, 620-2, 620-K) representing a K number of processor cores 622 and a second processor chiplet (616-N) having three processor cores (e.g., 622-1, 622-2, 622-L) representing an L number of processor cores 622, in other implementations (L being an integer number greater than or equal to one), each processor chiplet 616 may have any number of processor cores 620, 622. For example, each processor chiplet 616 can have the same number of processor cores 620, 622 as one or more other processor chiplets 616, a different number of processor cores 620, 622 as one or more other processor chiplets 616, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 600, the base die 104 and/or the stacked die 102 are communicatively coupled to an I/O circuitry 612 by a connection circuitry 624. For example, each processor chiplet 616 is communicatively coupled to the I/O circuitry 612 by the connection circuitry 624. The connection circuitry 624 includes, for example, one or more data fabrics, buses, buffers, queues, and the like. The I/O circuitry 612 is configured to facilitate communications between two or more components of the processing system 600 such as between the base die 104 and the stacked die 102, system memory 606, display 626, universal serial bus (USB) devices, peripheral component interconnect (PCI) devices (e.g., I/O device 608, AU 610), storage 614, and the like.

As an example, system memory 606 includes any combination of one or more volatile memories and/or one or more non-volatile memories, examples of which include dynamic random-access memory (DRAM), static random-access memory (SRAM), non-volatile RAM, and the like. To manage access to the system memory 606 by the base die 104 and the stacked die 102, the I/O device 608, the AU 610, and/or any other components, the I/O circuitry 612 includes one or more memory controllers 628. These memory controllers 628, for example, include circuitry configured to manage and fulfill memory access requests issued from the base die 104 and/or the stacked die 102, the I/O device 608, the AU 610, or any combination thereof. Examples of such requests include read requests, write requests, fetch requests, pre-fetch requests, or any combination thereof. That is to say, these memory controllers 628 are configured to manage access to the data stored at one or more memory addresses within the system memory 606, such as by the base die 104, the stacked die 102, the I/O device 608, and/or the AU 610.

When an application is to be executed by processing system 600, the OS 604 running on the base die 104 and/or the stacked die 102 (e.g., a CPU) is configured to load at least a portion of program code 630 (e.g., an executable file) associated with the application from, for example, a storage 614 into system memory 606. This storage 614, for example, includes a non-volatile storage such as a flash memory, solid-state memory, hard disk, optical disc, or the like configured to store program code 630 for one or more applications.

To facilitate communication between the storage 614 and other components of processing system 600, the I/O circuitry 612 includes one or more storage connectors 632 (e.g., universal serial bus (USB) connectors, serial AT attachment (SATA) connectors, PCI Express (PCIe) connectors) configured to communicatively couple storage 614 to the I/O circuitry 612 such that I/O circuitry 612 is capable of routing signals to and from the storage 614 to one or more other components of the processing system 600.

In association with executing an application, in one or more scenarios, the base die 104 and the stacked die 102 are configured to issue one or more instructions (e.g., threads) to be executed for an application to the AU 610. The AU 610 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 610 includes one or more compute units that concurrently execute one or more threads of an application and store data resulting from the execution of these threads in AU memory 634. This AU memory 634, for example, includes any combination of one or more volatile memories and/or non-volatile memories, examples of which include caches, video RAM (VRAM), or the like. In one or more implementations, these compute units are also configured to execute these threads based on the data stored in one or more physical registers 636 of the AU 610.

To facilitate communication between the AU 610 and one or more other components of processing system 600, the I/O circuitry 612 includes or is otherwise connected to one or more connectors, such as PCI connectors 638 (e.g., PCIe connectors) each including circuitry configured to communicatively couple the AU 610 to the I/O circuitry such that the I/O circuitry 612 is capable of routing signals to and from the AU 610 to one or more other components of the processing system 600. Further, the PCIe connectors 638 are configured to communicatively couple the I/O device 608 to the I/O circuitry 612 such that the I/O circuitry 612 is capable of routing signals to and from the I/O device 608 to one or more other components of the processing system 600.

By way of example and not limitation, the I/O device 608 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 608 is configured to execute one or more operations, tasks, instructions, or any combination thereof based on one or more physical registers 640 of the I/O device 608. In one or more implementations, such physical registers 640 are configured to maintain data (e.g., operands, instructions, values, variables) indicating one or more operations, tasks, or instructions to be performed by the I/O device 608.

To manage communication between components of the processing system 600 (e.g., AU 610, I/O device 608) that are connected to PCI connectors 638, and one or more other components of the processing system 600, the I/O circuitry 612 includes PCI switch 642. The PCI switch 642, for example, includes circuitry configured to route packets to and from the components of the processing system 600 connected to the PCI connectors 638 as well as to the other components of the processing system 600. As an example, based on address data indicated in a packet received from a first component (e.g., a CPU), the PCI switch 642 routes the packet to a corresponding component (e.g., an AU 610) connected to the PCI connectors 638.

Based on the processing system 600 executing a graphics application, for instance, the base die 104, the AU 610, or any combination thereof are configured to execute one or more instructions (e.g., draw calls) such that a scene including one or more graphics objects is rendered. After rendering such a scene, the processing system 600 stores the scene in the storage 614, displays the scene on the display 626, or both. The display 626, for example, includes a cathode-ray tube (CRT) display, liquid crystal display (LCD), light emitting diode (LED) display, organic light emitting diode (OLED) display, or any combination thereof. To enable the processing system 600 to display a scene on the display 626, the I/O circuitry 612 includes display circuitry 644. The display circuitry 644, for example, includes high-definition multimedia interface (HDMI) connectors, DisplayPort connectors, digital visual interface (DVI) connectors, USB connectors, and the like, each including circuitry configured to communicatively couple the display 626 to the I/O circuitry 612. Additionally or alternatively, the display circuitry 644 includes circuitry configured to manage the display of one or more scenes on the display 626 such as display controllers, buffers, memory, or any combination thereof.

Further, the base die 104, the AU 610, or any combination thereof are configured to concurrently run one or more virtual machines (VMs), which are each configured to execute one or more corresponding applications. To manage communications between such VMs and the underlying resources of the processing system 600, such as any one or more components of processing system 600, including the base die 104, the I/O device 608, the AU 610, and the system memory 606, the I/O circuitry 612 includes memory management unit (MMU) 746 and input-output memory management unit (IOMMU) 648. The MMU 646 includes, for example, circuitry configured to manage memory requests, such as from the base die 104 and/or the stacked die 102 to the system memory 606. For example, the MMU 646 is configured to handle memory requests issued from the base die 104 and the stacked die 102 and associated with a VM running on the base die 104 and/or the stacked die 102 (e.g., a CPU). These memory requests, for example, request access to read, write, fetch, or pre-fetch data residing at one or more virtual addresses (e.g., guest virtual addresses) each indicating one or more portions (e.g., physical memory addresses) of the system memory 606. Based on receiving a memory request from the base die 104 or the stacked die 102, the MMU 646 is configured to translate the virtual address indicated in the memory request to a physical address in the system memory 606 and to fulfill the request. The IOMMU 648 includes, for example, circuitry configured to manage memory requests (memory-mapped I/O (MMIO) requests) from the base die 104 or the stacked die 102 to the I/O device 608, the AU 610, or both, and to manage memory requests (direct memory access (DMA) requests) from the I/O device 608 or the AU 610 to the system memory 606. For example, to access the registers 640 of the I/O device 608, the registers 636 of the AU 610, and/or the AU memory 634, the base die 104 or the stacked die 102 issues one or more MMIO requests. Such MMIO requests each request access to read, write, fetch, or pre-fetch data residing at one or more virtual addresses (e.g., guest virtual addresses) which each represent at least a portion of the registers 640 of the I/O device 608, the registers 636 of the AU 610, or the AU memory 634, respectively. As another example, to access the system memory 606 without using the base die 104 or the stacked die 102 (e.g., the CPU), the I/O device 608, the AU 610, or both are configured to issue one or more DMA requests. Such DMA requests each request access to read, write, fetch, or pre-fetch data residing at one or more virtual addresses (e.g., device virtual addresses) which each represent at least a portion of the system memory 606. Based on receiving an MMIO request or DMA request, the IOMMU 648 is configured to translate the virtual address indicated in the MMIO or DMA request to a physical address and fulfill the request.

In variations, the processing system 600 can include any combination of the components depicted and described. For example, in at least one variation, the processing system 600 does not include one or more of the components depicted and described in relation to FIG. 6. Additionally or alternatively, in at least one variation, the processing system 600 includes additional and/or different components from those depicted. The processing system 600 is configurable in a variety of ways with different combinations of components in accordance with the described techniques.

What is claimed is:

1. A processor comprising:
one or more processor cores on a first die; and
a metadata controller on the first die and communicatively coupled to the one or more processor cores, the metadata controller configured to store metadata generated by the one or more processor cores in metadata storage on a second die.

2. The processor of claim 1, wherein the metadata controller is further configured to use a status table to monitor one or more sets of metadata stored in the metadata storage associated with one or more processes or one or more threads executed by the one or more processor cores.

3. The processor of claim 2, wherein the metadata controller is further configured to identify, using the status table, a location of metadata associated with a process or a thread in the metadata storage in response to a context switch.

4. The processor of claim 1, wherein:
the first die includes multiple processor cores, each processor core including a corresponding metadata controller; and
the metadata storage includes multiple metadata storage slices, each metadata storage slice associated with a corresponding processor core and storing the metadata associated with the corresponding processor core.

5. The processor of claim 4, wherein each metadata controller is further configured to use a shared status table to monitor one or more sets of metadata stored in the multiple metadata storage slices, each entry in the shared status table including an identifier of a processor core that generated a corresponding set of metadata, a slice identifier of a metadata storage slice storing the corresponding set of metadata, and an address space identifier or process context identifier associated with a process or a thread that generated the corresponding set of metadata.

6. The processor of claim 4, wherein the multiple metadata storage slices use a unified metadata cache address space with each metadata storage slice having a unique starting memory address.

7. A method comprising:
generating, by a first process or a first thread of a processor on a first die, metadata; and
in response to a context switch of the processor to a second process or a second thread, causing, by a metadata controller of the processor, the metadata to be saved in metadata storage of a second die.

8. The method of claim 7, wherein the method further comprises:
in response to the context switch to the second process or the second thread, determining, by the metadata controller, whether other metadata associated with the second thread or second process is stored in the metadata storage.

9. The method of claim 8, wherein the method further comprises:
in response to determining that the other metadata associated with the second thread or the second process is stored in the metadata storage, loading the other metadata into one or more corresponding components of the processor.

10. A system comprising:
a first die comprising one or more processor cores; and
a second die comprising metadata storage configured to store metadata generated by the one or more processor cores.

11. The system of claim 10, wherein the second die is stacked on, below, or beside the first die.

12. The system of claim 10, wherein:
the first die includes multiple processor cores; and
the second die includes multiple metadata storage slices, each metadata storage slice of the multiple metadata storage slices associated with a corresponding processor core of the multiple processor cores.

13. The system of claim 12, wherein:
the first die further comprises multiple shared cache slices; and
the second die further comprises multiple cache slices, each cache slice of the multiple cache slices associated with a corresponding shared cache slice.

14. The system of claim 13, wherein the system further comprises:
a metadata interface communicatively coupling each metadata storage slice to the corresponding processor core; and
a data interface communicatively coupling each cache slice to the corresponding shared cache slice, the metadata interface located closer to components of the corresponding processor core than the data interface.

15. The system of claim 14, wherein the metadata interface is inaccessible by an operating system, a hypervisor, or an application associated with the multiple processor cores.

16. The system of claim 13, wherein the multiple metadata storage slices and the multiple cache slices comprise dynamic random access memory (DRAM), embedded DRAM, static random access memory (SRAM), or nonvolatile memory.

17. The system of claim 10, wherein the metadata comprises at least one of branch prediction history, branch target buffer entries, instruction prefetcher training, instruction prefetcher pattern history, data prefetcher training, data prefetcher pattern history, or memory dependence predictor states.

18. The system of claim 17, wherein the metadata further comprises at least one of software logs for one or more applications executed by the one or more processor cores, performance logs for the one or more processor cores, or hardware debugging data for the one or more processor cores.

19. The system of claim 10, wherein the metadata includes multiple metadata sets, each metadata set associated with a particular process or a particular thread executed by the one or more processor cores.

20. The system of claim 19, wherein a metadata set associated with a first process or a first thread is saved to the metadata storage in response to a context switch to a second process or a second thread at the one or more processor cores.
